(19) United States
(12) Patent Application Publication
(10) Pub. No.: US 2024/0142121 A1
(43) Pub. Date: May 2, 2024

(54) simulating flame humidifier

(71) Applicant: Dongguan Yiting Household Products Technology Co., Ltd., Dongguan City (CN)

(72) Inventor: ShiBo Liu, Dongguan City (CN)

(21) Appl. No.: 18/410,319

(22) Filed: Jan. 11, 2024

Related U.S. Application Data
(63) Continuation of application No. 17/652,676, filed on Feb. 25, 2022.

(51) Int. Cl. F24F 6/12; F21S 10/04

(52) U.S. Cl. CPC F24F 6/12; F21S 10/04; F24F 2006/008

(57) ABSTRACT

A simulating flame humidifier includes a main engine, an upper shell detachably connected to the main engine, and an emitting-light assembly; the main engine is provided with a spray chamber, a bottom surface of the spray chamber is provided with an atomizer; the upper shell is provided with a spraying port communicated with the spray chamber; the emitting-light assembly is arranged in the spray chamber and aligned with the spraying port; the emitting-light assembly is used for generating a light with flame color and illuminating the water mist from the spray port; the bottom surface of the spray chamber extends upwardly to form a chamber aligned to the spraying port, a top portion of the chamber is made of transparent material, the emitting-light assembly is arranged in the top portion of the chamber.

### CROSS REFERENCE TO RELATED APPLICATION

This application is a continuation of U.S. application Ser. No. 17/652,676, entitled “SIMULATING FLAME HUMIDIFIER,” filed Feb. 25, 2022, and the entire contents of which are incorporated herein by reference.

### FIELD OF THE INVENTION

The present invention relates to the technical field of household articles, more particularly, relates to a simulating flame humidifier.

### BACKGROUND OF THE INVENTION

Humidifiers are a kind of domestic appliance that increases room humidity. The humidifiers can humidity for a specified room, and also can be humidity for a whole building connected with a boiler or a central air conditioning system. With the development of the economy and the improvement of people's living standards, the demands for life quality and health are getting higher and higher, air humidifiers become a kind of necessary small appliance for homes in dry areas.

With the improvement of people's living conditions, people's pursuit of life quality is getting higher and higher. The demands for air humidifiers are getting higher and higher, the air humidifiers are not only demanded to humidity air, but also demanded to decorate the indoor environment as decorations. To cater to the consumers' consumption concept, a kind of simulating flame humidifier has emerged. The humidifiers illuminate the water mist emitted from its interior through a light-emitting element inside its interior so that the original colorless water mist presents a kind of water mist with a flame color, combined with the flow effect of the water mist, to create a simulating flame.

However, in the existing simulating flame humidifiers, its internal outlet is lower than its water chamber, when users add too much liquid, the liquid will enter the fan assembly from the internal outlet, which will damage the humidifier and it is not safe. The users must observe the water line in the water chamber. And because the air in the outlet flows uniformly in the cavity of the humidify and the shape of the spray port is not changed, the shape of the water mist in the existing humidifier is somewhat different from the real flame, and the simulation effect is not good.

### SUMMARY OF THE INVENTION

The present invention aims to solve the technical problems about the safety of the existing simulating flame humidifier and the bad simulation effect of the flame. The present invention provided a simulating flame humidifier, the air passage of the air chamber in the chamber can prevent the liquid from entering the fan assembly, and the airflow in the chamber is more uniform, combining with a new spray port, the flame simulation effect of the water mist in the spray mouth is more real.

The simulating flame humidifier in an embodiment according to the present invention, includes a main engine and an upper shell delectably connected to the main engine. The main engine is provided with a spray chamber, and the bottom of the spray chamber is provided with an atomizer. The upper shell is provided with a spraying port communicated with the spray chamber.

The simulating flame humidifier also includes an emitting-light assembly, arranged in the spray chamber and aligned with the spraying port; the emitting-light assembly is used for generating light with a flame color and illuminating the water mist from the spray port.

The simulating flame humidifier also includes an inner shell, arranged in the upper shell and used for covering the spray chamber to form a closed chamber to prevent the water mist from dispersing. The inner shell is provided with a molding groove communicated with the spray port and the spray chamber respectively.

The simulating flame humidifier also includes an air chamber arranged on the spray chamber. The air chamber is above the top surface of the spray chamber. The inner shell is provided with a baffle corresponding to the air chamber, the baffle forms a passageway to adjust the path of the airflow in the air chamber. The molding groove is aligned with the emitting-light assembly, the molding groove is provided with two water mist baffles respectively, used to adjust the path of the water mist spraying from the spraying port.

In an embodiment according to the present invention, the bottom of the spray chamber extends upwards to form a chamber aligned with the spraying port, the emitting-light assembly is arranged in the chamber, and the top surface of the chamber is made from transparent material.

In an embodiment according to the present invention, the inner shell is delectably connected with the spray chamber, and the inner shell is connected with the upper shell, and is removed or installed synchronously with the upper shell.

In an embodiment according to the present invention, the molding groove matches with the chamber. After the inner shell is connected with the spray chamber, the water mist baffles of molding groove fits with both side of the top surface of the chamber, the molding groove has two opposite sidewalls, the two opposite sidewalls are respectively provided with two openings communicated with the spray chamber, the water mist enters the spraying port from the two openings.

In an embodiment according to the present invention, the opening area of the spraying port is less than that of the molding groove, the joint position of the molding groove and the spraying port is arc-shaped.

In an embodiment according to the present invention, the bottom of the main engine is provided with a fan assembly communicated with the air chamber and used for blowing wind into the spray chamber.

In an embodiment according to the present invention, the main engine is provided with an air passage extending perpendicularly to the bottom of the main engine and communicated with the spray chamber, the air chamber is provided with a hole.

In an embodiment according to the present invention, a rectifying cavity is arranged between the baffle and the hole forms, and the rectifying cavity is communicated with the spray chamber.

In an embodiment according to the present invention, the main engine is provided with a control assembly, coupled electrically with the atomizer and the light-emitting mechanism.

In an embodiment according to the present invention, the side wall of the main engine is provided with a button and a lighter, coupled electrically with the control assembly.

In an embodiment according to the present invention, the simulating flame humidifier also includes an annular inner shell connected with the spray chamber to form a closed cavity; the annular inner shell is provided with a diversion channel communicated with the spray chamber and the spraying port, the water mist generated by the atomizer is accumulated and flowed into the diversion channel, and sprayed out from the spraying port.

In an embodiment according to the present invention, a plurality of air inlet slots are provided at the periphery of the annular inner shell; the air inlet slots are communicated with the spay chamber; each of the air inlet slots has a side wall perpendicular to the annular inner shell and a bottom wall obliquely extending from the side wall toward the side wall of the spray chamber to form an air inlet.

The upper shell is connected with the main engine to form an annular air duct between the spay chamber and the upper wall, the annular air duct is communicated with each of the air inlet slots.

The diversion channel of the annular inner shell is gradually narrowed in size from the side close to the spray chamber to the other side close to the spray port.

In an embodiment according to the present invention, the simulating flame humidifier has the following advantages: the air chamber is above the spray chamber, it can prevent the liquid from entering the interior of the simulating flame humidifier and damaging the simulating flame humidifier. And the baffles are arranged at the air chamber to adjust the airflow in the spray chamber to make the airflow more uniform and make the water mist sprayed out from the spraying port more like the flame. The water mist baffles of the molding groove in the inner shell can adjust the spraying path of the water mist at the spraying port, enabling the flow effect presented by the water mist more realistic

### BRIEF DESCRIPTION OF THE DRAWINGS

In order to more clearly illustrate the technical schemes in the embodiment in the present invention, the drawings needed in the embodiment or the prior technical description are briefly introduced below. Obviously, the drawings described below are only some embodiments in the present invention, and for those skilled in the art, additional drawings may be obtained according to the drawings below without creative work.

FIG. 1 is a perspective view of the simulating flame humidifier in an embodiment according to the present invention.

FIG. 2 is a first section view of the simulating flame humidifier in an embodiment according to the present invention.

FIG. 3 is a second section view of the simulating flame humidifier in an embodiment according to the present invention.

FIG. 4 is a perspective view of the inner shell of the simulating flame humidifier in an embodiment according to the present invention.

FIG. 5 is a perspective view of the spray chamber of the simulating flame humidifier in an embodiment according to the present invention.

FIG. 6 is a perspective view of the simulating flame humidifier in an embodiment according to the present invention.

FIG. 7 is a section view of the simulating flame humidifier shown in FIG. 6.

FIG. 8 is a perspective view of the annular inner cover of the simulating flame humidifier in an embodiment according to the present invention.

FIG. 9 is the other section view of the simulating flame humidifier in an embodiment according to the present invention.

FIG. 10 is the other perspective view of the simulating flame humidifier in an embodiment according to the present invention.

### DETAILED DESCRIPTION OF ILLUSTRATED EMBODIMENTS

In order to make the invention purpose, the technical scheme and the technical effect more clearly be understood, the invention is further explained in combination with the concrete embodiment below. It should be understood that the specific embodiments described herein are only used to interpret the invention and are not used to limit the invention.

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limited.

In the embodiments of the invention, unless otherwise clearly specified and defined, the terms, “installed”, “connected”, “or” fixed “should be generally understood, for example, a fixed connection, or a removable connection, a mechanical connection or an electrical connection, or a direct connection or an indirect connection through an intermediate media, or a connection within two elements or the interaction of two elements. For those of ordinary skilled in the art, the specific meaning of the above terms in the embodiment of the present invention may be understood under specific circumstances.

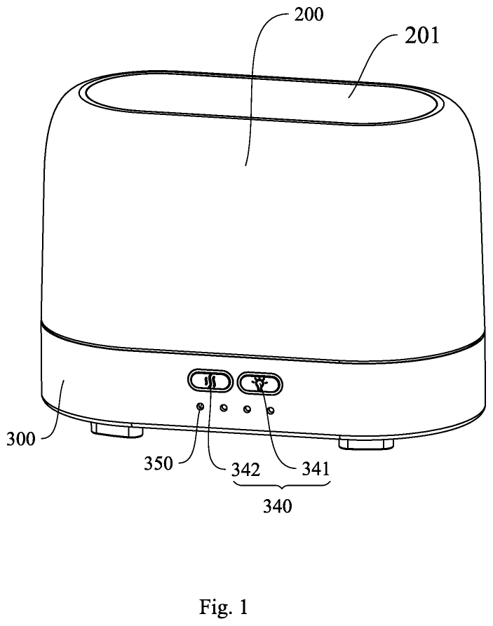

Referring to FIG. 1-FIG. 5, a simulating flame humidifier includes a main engine 300 and an upper shell 200 detachably connected to the main engine 300. The main engine 300 is provided with a spray chamber 100, and the bottom surface 101 of the spray chamber 100 is provided with an atomizer 110. Specifically, the bottom surface 101 of the spray chamber 100 is not arranged horizontally, but obliquely towards the atomizer 110 to ensure that no water accumulates in the corner of the spray chamber 100 and avoid the water in the spray chamber 100 from being contaminated. The upper shell 200 is provided with a spraying port 201 communicated with the spray chamber 100 so that the water mist generated by the atomizer 110 can be spayed out through the spaying port 201.

The simulating flame humidifier also includes an emitting-light assembly 310, arranged in the spray chamber 100 and aligned with the spraying port 201. The emitting-light assembly 310 is used for generating light with a flame color and illuminating the water mist in the spray port 201. When the water mist is spayed out through the spaying port 201, the light with flame color generated by the emitting-light assembly 310 illuminates it, the light is refracted in the water mist to display a flame shape, simulating the appearance of the real flame.

In order to prevent the water mist in the spray chamber 100 from dispersing, ensure the water mist to be sprayed out uniformly from the spraying port 201, the simulating flame humidifier also includes an inner shell 210 arranged in the upper shell 200 and used for covering the spray chamber 100 to form a closed chamber. The inner shell 210 is provided with a molding groove 211 at a position corresponding to the spraying port 201, the molding groove 211 is communicated with the spraying port 201 and the spray chamber 100 respectively so that the only flowing path of the water mist in the spray chamber 100 is from the molding groove 211 to the spraying port 201, which ensures that all of the water mist is sprayed out from the spraying port 201, and the flow amount of the water mist is larger, the flame effect is more realistic.

In order to make the water mist at the spraying port 201 flow faster and form a more realistic flame effect, the simulating flame humidifier is also provided with an air chamber 120 arranged on the spray chamber 100. The external air is blown into the spray chamber 100 from the air chamber 120 so that the water mist in the spray chamber 100 can flow faster, increasing the flow amount of the water mist. If the user adds too much water into the spray chamber 100, the water will overflow from the air chamber 120 to damage the simulating flame humidifier. In order to avoid the damage, the position of the air chamber 120 is on the top surface of the spray chamber 100. Specifically, the air chamber 120 is above a connecting position of the spray chamber 100 and the inner shell 210. When the water level in the spray chamber 100 is too high, the water will preferentially be discharged from the connection of the spray chamber 100 and the inner shell 210, but not enter the air chamber 120. The inner shell 210 is provided with a baffle 213 corresponding to the air chamber 120, the baffle 213 forms a passageway to adjust the path of the airflow from the air chamber 120 so that the air can be evenly distributed in the spray chamber 100, enabling the water mist to be sprayed more naturally from the spraying port 201, presenting a more realistic flame effect.

The molding groove 211 is aligned with the emitting-light assembly 310 so that the light from the emitting-light assembly 310 can better illuminate the water mist from the modeling groove 211 to the spraying port 201. In the embodiment according to the present invention, the emitting-light assembly 310 is in a long strip shape with opposite two ends 311, the molding groove 211 is provided with two water mist baffles 212 respectively corresponding to the opposite two ends 311 of the emitting-light assembly 310 the water mist baffles 212 are used for adjusting the spraying path of the water mist at the spraying port 201 to make the simulating flame more realistic.

Specifically, the air chamber 120 is above the highest liquid level in the spray chamber 100, which can prevent the water from entering the interior of the simulating flame humidifier from the air chamber 120 and damaging the simulating flame humidifier. And the baffle 213 is arranged at the air chamber 120 to adjust the airflow in the spray chamber 100 to make the airflow more uniform and make the water mist be sprayed out from the spraying port 201 more like the flame. The water mist baffles 212 of the molding groove 211 in the inner shell 210 can adjust the spraying path of the water mist at the spraying port 201, enabling the flow effect presented by the water mist more realistic.

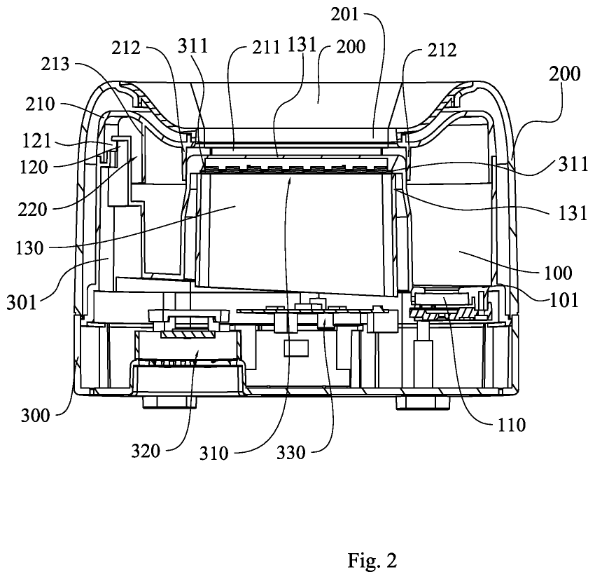

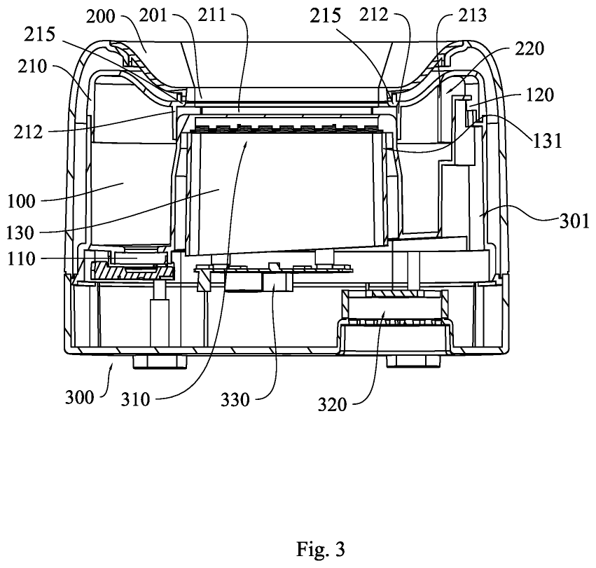

In an embodiment according to the present invention, referring to FIG. 2 and FIG. 3, specifically, the bottom surface 101 of the spray chamber 100 extends upwards to form a chamber 130 aligned to the spraying port 201, the emitting-light assembly 310 is arranged in a top portion 131 of the chamber 130, a top portion 131 of the chamber 130 is made from transparent material. The spray chamber 100 and the chamber 130 are integrated, thereby preventing the water from entering the emitting-light assembly 310 and damaging the emitting-light assembly 310. The top surface 131 of the chamber 130 is transparent, which ensures that the light of the emitting-light assembly 310 is illuminated from the chamber 130 to the spray chamber 100.

In an embodiment according to the present invention, the emitting-light assembly 310 is a LED element, the LED element has the characteristics of low heat generation, long life, and stable color temperature. It can work for a long time without aging, keep the color of the simulated flame without distortion, and make the simulating flame humidifier work stably for a long time.

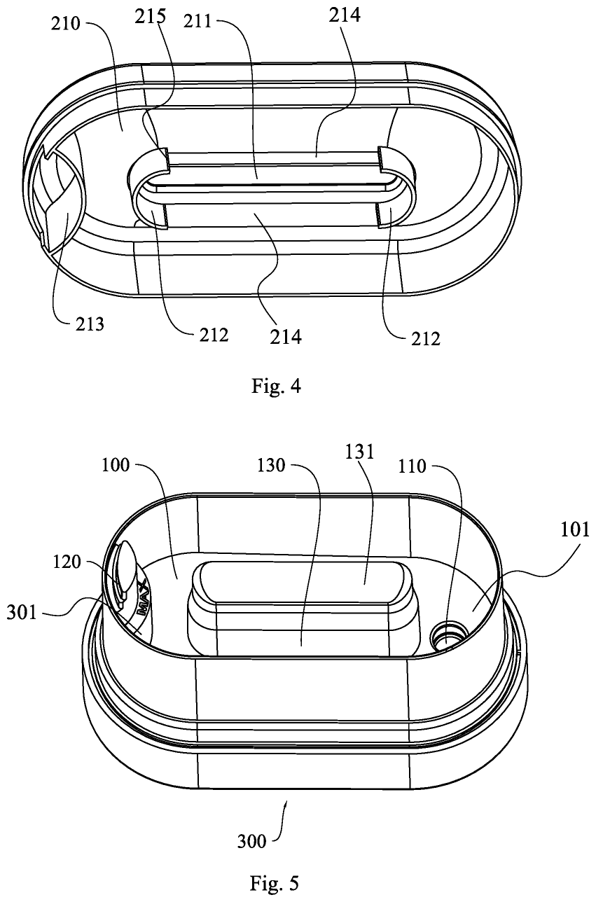

In an embodiment according to the present invention, referring to FIG. 2, FIG. 3, and FIG. 4, the inner shell 210 is detachably connected with the spray chamber 100, the inner shell 210 is connected with the upper shell 200 and is removed or installed synchronously with the upper shell 200. The inner shell 210 and the upper shell 200 are connected to form a double-layer shell. In the process of mounting to the main engine 310, the upper shell 200 is covered on the main engine 300, the inner shell 210 is covered on the spray chamber 100. Even if the water level in the spray chamber 100 is too high, the water can overflow into a space between the main engine 300 and the upper shell 200 from a connection position between the inner shell 210 and the spray chamber 100, then flow out from the space between the main engine 300 and the upper shell 200 and do not enter the interior of the main engine 300, so that the simulating flame humidifier has good drainage performance.

In an embodiment according to the present invention, referring to FIG. 2, FIG. 3, and FIG. 4, the molding groove 211 matches with the chamber 130. After the inner shell 210 is covered on the spray chamber 100, the water mist baffles 212 respectively fit with both sides of the top surface 131 of the chamber 130, the molding groove 211 has two opposite sidewalls 215, the two opposite sidewalls 215 are provided with an opening 214 respectively communicated with the spray chamber 100, the water mist in the spray chamber 100 enters the spraying port 201 from the openings 214 of the molding groove 211.

Specifically, the water mist baffles 212 are U-shaped and arranged at the two ends of the molding groove 211. When water mist enters the spray chamber 100 from the openings 214 on the sidewalls of the molding groove 211, the flow direction of the water mist is parallel, while the light of the emitting-light assembly 310 is constantly refracted and reflected between the two parallel rising water mists, making the flame effect of the water mist more brilliant and flexible. In addition, it can prevent a part of the liquefied water mist from hanging on the inner shell 210, and the liquefied water mist returns to the spray chamber 100 under the action of gravity, reducing the residual water and keeping the interior of the spray chamber 100 clean.

In an embodiment according to the present invention, referring to FIG. 2 and FIG. 3, the opening area of the spraying port 201 is less than that of the molding groove 211, the joint position of the molding groove 211 and the spraying port 201 is arc-shaped. When the water mist in the molding groove 211 enters the spraying port 201, the flow rate of the water mist will increase, thereby the water mist will flow faster, simulating the flame more realistically.

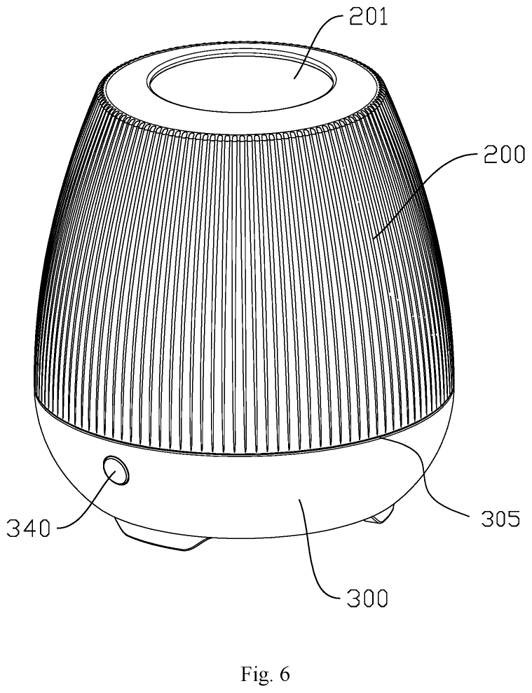

In an embodiment according to the present invention, referring to FIG. 2, FIG. 3, and FIG. 5, the bottom of the main engine 300 is provided with a fan assembly 320 used for blowing air into the spray chamber 100. The fan assembly 320 faces a side of the upper shell 200. The fan assembly 320 sends the wind into the spray chamber 100 through the air chamber 120, and the air circulates evenly in the spray chamber 100.

Specifically, the main engine 300 is provided with an air passage 301 communicating with the air chamber 120, the air passage 301 extends perpendicularly from the bottom of the main engine 300 towards the air chamber 120. The air chamber 120 is provided with a hole 121 perpendicular to the air passage 301 and close to the spray chamber 100. In order to avoid excessive liquid from entering the air chamber 120, the position of the hole 121 is higher than the spray chamber 100, and the hole 121 is above the spray chamber 100.

It should be understood that the hole 121 can be arranged on the top of the air chamber 120. Ensuring that the position of the hole is above the spray chamber 100 to prevent the liquid from overflowing into the air passage of the air chamber 120.

In an embodiment according to the present invention, referring to FIG. 2 and FIG. 3, a rectifying cavity 220 is arranged between the baffle 213 and the hole 121, the rectifying cavity 220 is communicated with the spray chamber 100. Specifically, the flowing air from the air chamber 120 into the spray chamber 100 first passes through the rectifying cavity 220, reducing the flow rate and increasing the area of the flowing air, thereby the air is evenly filled with the spray chamber 100 forming a stable flow effect of the water mist at the spraying port 201.

In an embodiment according to the present invention, referring to FIG. 2 and FIG. 3, the main engine 300 is provided with a control assembly 330, coupled electrically with the atomizer 110 and the emitting-light assembly 310. The side wall of the main engine is provided with a button 340 and a lighter 350, coupled electrically with the control assembly 330. Specifically, the button 340 includes a light adjusting button 341 and a spray adjusting button 342, with the indicator lamp 350 are corresponding to a light adjusting button 341 and a spray adjusting button 342, respectively, to indicate a light adjusting level and a spray adjusting level.

Referring to FIG. 8-FIG. 10, which shows another simulating flame humidifier, which includes a main engine 300 and an upper shell 200 detachably connected to the main engine 300. The main engine 300 is provided with a spray chamber 100, and the bottom surface 101 of the spray chamber 100 is provided with an atomizer 110. A top end of the upper shell 200 is provided with the spraying port 201 communicated with the spray chamber 100 so that the water mist generated by the atomizer 110 can be spayed out through the spaying port 201. The main engine 300 and the upper shell 200 are connected detachably which is convenient for cleaning the spray chamber 100.

The upper shell 200 is provided with an annular inner shell 230 connected with the spray chamber 100 to form a closed cavity, ensuring the water mist in the spay chamber 100 to be sprayed out uniformly from the spraying port 201. The annular inner shell 230 is provided with a diversion channel 231 communicated with the spray chamber 100 and the spraying port 201, the water mist generated by the atomizer 110 is accumulated and flowed into the diversion channel 231, and sprayed out from the spraying port 201.

In order to make the water mist in the spay chamber 100 flow faster, a plurality of air inlet slots 232 are provided at the periphery of the annular inner shell 230. The air inlet slots 232 are communicated with the spay chamber 100. The upper shell 200 is connected with the main engine 300 to form an annular air duct 370 between the spay chamber 100 and the upper wall 200, the annular air duct 370 is communicated with each of the air inlet slots 222.

In an embodiment according to the present invention, the fan assembly 320 is arranged in the main engine 300 and used for supplying wind into the annular air duct 370. The wind in the annular air duct 370 passes through the plurality of air inlet slots 232 and enters the spray chamber 100, In the flowing process, the wind is adjusted and distributed evenly in the atomizer 110 so that the flow rate and stability of the water mist sprayed out of the spraying port 201 can be adjusted to make the water mist spray more stable and simulate the fluidity of the real flame.

In an embodiment according to the present invention, the simulating flame humidifier also includes the emitting-light assembly 310, arranged in the spray chamber 100 and aligned with the spraying port 201. The emitting-light assembly 310 is used for generating light with a flame color and illuminating the water mist in the spray port 201. When the water mist is spayed out through the spaying port 201, the light with flame color generated by the emitting-light assembly 310 illuminates it, the light is refracted in the water mist to display a flame shape, simulating the appearance of the real flame. In an embodiment according to the present invention, the emitting-light assembly 310 is a LED element, the LED element has the characteristics of low heat generation, long life, and stable color temperature. It can work for a long time without aging, keep the color of the simulated flame without distortion, and make the simulating flame humidifier work stably for a long time.

Specifically, with the above upper shell 200 and the spraying port 201, the water mist in the spray chamber 100 can be sprayed out from the diversion channel 231 of the annular inner shell 230 to form a 360° surrounding spray effect, filling light to the surround spray with the light emitting device 310, so that the simulated flame keep the same look from any angle to view. Thus, the simulating flame humidifier can be placed at any place in the room. The annular air duct 370, the air inlet slots 232, and the diversion channel 231 form an air duct making air into the spray chamber 100 more uniform and making the water mist emitted from the spray port 201 closer to the simulated flame.

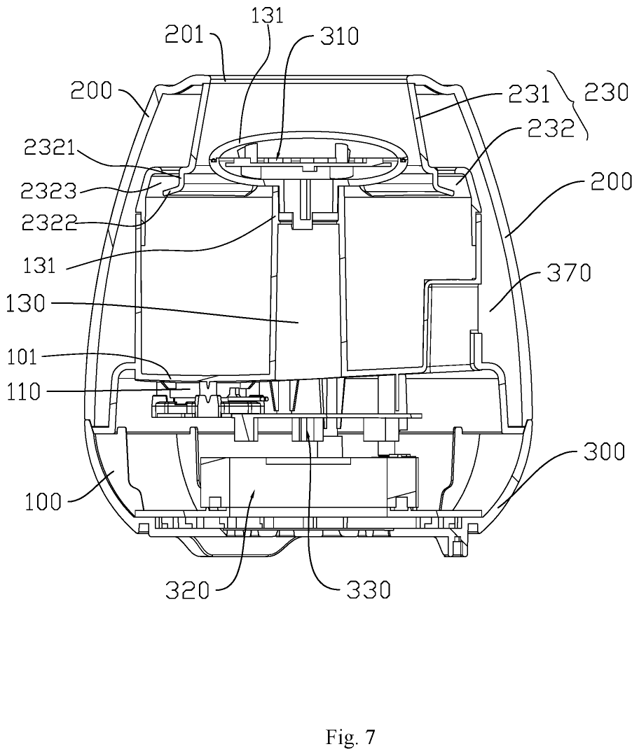

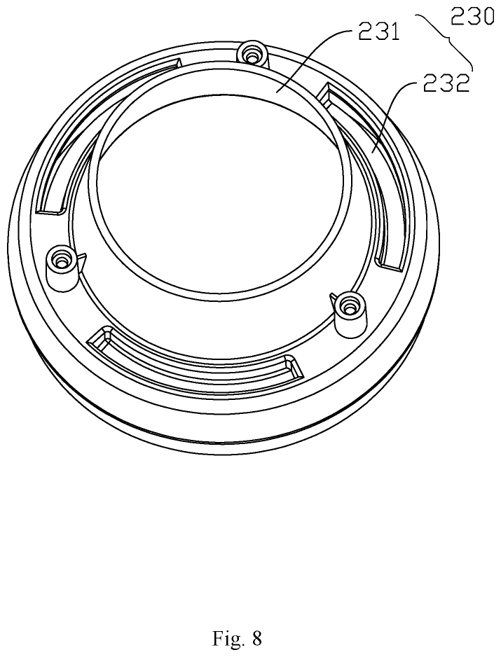

In an embodiment according to the present invention, referring to FIG. 7 and FIG. 8, the plurality of air inlet slots 232 are distributed equally spaced around the periphery of the annular inner shell 230. Specifically, the diversion channel 231 of the annular inner shell 230 extends towards the spray port 201. In the embodiment, the periphery of the annular inner shell 230 is provided with three of the air inlet slots 232, in arc shape and distributed equally spaced, to ensure the same air inlet effect around the periphery of the annular inner shell 230 so that the air flowing in the annular air duct 370 can be adjusted and stably enter the spray chamber 100. Each of the air inlet slots 232 has a side wall 2321 perpendicular to the annular inner shell 230 and a bottom wall 2322 extending from the side wall 2321 toward the side wall of the spray chamber 100 to form an air inlet 2323. After the air flowing in the annular air duct 370 enters the air inlet slots 232, it is adjusted and decelerated for the first time, after the air reaches the air inlet 2223, it must turn 90° to enter the spray chamber 100, it is adjusted and decelerated for the second time. After being adjusted twice, the air enters the spray chamber 100 with a uniform flow rate to smoothly push the water mist sprayed out from the spray port 201.

It should be understood that the number of the air inlet slots 232 can be changed according to the actual production demands, such as two, four, five, etc. And the size of the air inlet slots 232 can be changed according to the number of the air inlet slots 222. It should be understood that the number of the air inlet slots 232 without leaving the basic conception of the air inlet slots 232 should be considered within the protection scope limited by the present invention.

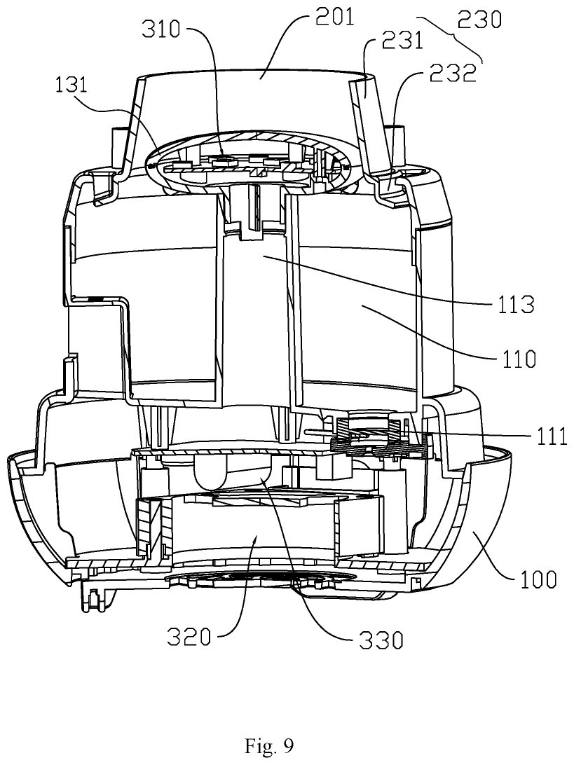

In an embodiment according to the present invention, referring to FIG. 7 and FIG. 9, the bottom wall 2322 of the air inlet slots 232 are inclined toward the side wall of the spray chamber 100. Specifically, a side of the bottom wall 2322 close to the interior of the spray chamber 100 is higher than the other side of the bottom wall 2322 close to the side wall of the spray chamber 100, when the water mist forms water beads on the side wall of the annular inner shell 230, the water beads will flow along the side wall of the annular inner shell 230 and accumulate at the other side of the bottom wall 2322, under the affect of gravity, the water beads eventually fall into the spray chamber 100 so as to avoid ponding and affect the cleanliness of the spray chamber 100.

In an embodiment according to the present invention, referring to FIG. 7 and FIG. 9, the diversion channel 231 of the annular inner shell 230 is gradually narrowed in size from the side closed to the spray chamber 100 to the other side closed to the spray port 201.

Specifically, under the premise of constant water mist, according to the characteristics of the water mist, reducing the size of the diversion channel 231 can increase the flow speed of the water mist. When the water mist enters the diversion channel 231, the size of the diversion channel 231 is gradually reduced, and the flow speed of the water mist will increase so that the sprayed water mist flows faster and better simulates the rising airflow around the flame, making the simulated flame more realistic.

In an embodiment according to the present invention, referring to FIG. 7 and FIG. 9, the bottom surface 101 of the spray chamber 100 extends up to form the chamber 130 in the direction of the diversion channel 231, the top portion 131 of the chamber 130 close to the diversion channel 231 is flat and elliptical and is made of transparent material. The light emitting device 130 is arranged in the top portion of the chamber 130.

Specifically, the top portion of the chamber 130 is provided with a transparent cover 131, the light emitting device 130 is arranged in the top portion of the chamber 130, and the transparent cover 131 covers the top portion of the chamber 130.

In an embodiment according to the present invention, referring to FIG. 7 and FIG. 9, the size of the bottom end of the diversion channel 231 is bigger than that of the top portion of the chamber 130, the top portion of the chamber 130 is arranged at the bottom end of the diversion channel 231 and forms an annular gap therebetween. When the water mist enters the diversion channel 231 from the annular gap so that the water mist flows in an annular ring shape, combined with the irradiation of the light-emitting assembly 310, the user looks at the water mist from any angle, and the simulated flame remains consistent.

In an embodiment according to the present invention, referring to FIG. 7 and FIG. 9, the bottom surface 101 of the spray chamber 100 is arranged obliquely, the atomizer 110 is provided at the lowest place of the bottom surface 101 of the spray chamber 100 so that the atomizer 110 can contact all liquid in the spray chamber 100 to ensure that the spray chamber 100 has no ponding and avoid the liquid in the spray chamber 100 from being contaminated.

In an embodiment according to the present invention, referring to FIG. 2, FIG. 7, FIG. 8, and FIG. 9, the annular inner shell 230 and the upper shell 200 are connected by screws to form a double-layer shell. The edge of the upper shell 200 covers the periphery of the main engine 300, and the edge of the annular inner shell 230 covers the periphery of the spray chamber 100.

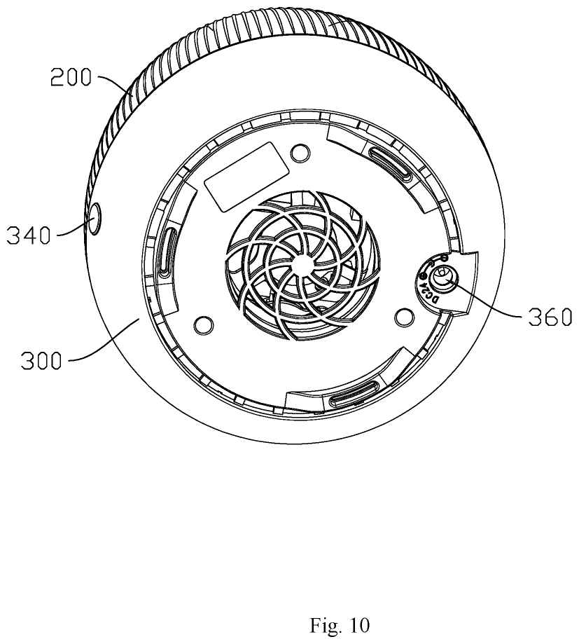

In an embodiment according to the present invention, referring to FIG. 7, FIG. 9, and FIG. 10, the main engine 300 is provided with a control assembly 330, which is electrically coupled with the atomizer 110 and the light-emitting assembly 310 and used for controlling them. The main engine 300 is provided with a controlling button 340 which is electrically coupled with the control assembly 330. The bottom of the main engine 300 is provided with a power interface 360, which is electrically connected to the control assembly 330 to power the power assembly 330 via external power adapters to the power interface 360 to drive the atomizer 110 and the light emitting assembly 310 to operate.

the main engine 300 is also provided with a power supply assembly which is electrically connected to the control assembly 330. When the external power supply is not used, the control assembly 330 is powered by the power supply assembly. When the power supply interface 360 is inserted into the power adapter, the power supply assembly is charged by the external power supply and drives the control assembly 330.

In an embodiment according to the present invention, referring to FIG. 6, the main engine 300 is provided with a light ring 305.

What is claimed is:

1. A simulating flame humidifier, comprising a main engine and an upper shell detachably connected to said main engine; said main engine is provided with a spray chamber, a bottom surface of said spray chamber is provided with an atomizer; said upper shell is provided with a spraying port communicated with said spray chamber; wherein also comprising:
an emitting-light assembly, arranged in said spray chamber and aligned with said spraying port;
said emitting-light assembly is used for generating light with a flame color and illuminating said water mist from said spray port;
said bottom surface of said spray chamber extends upwardly to form a chamber aligned to said spraying port, a top portion of said chamber is made of transparent material, said emitting-light assembly is arranged in said top portion of said chamber;
wherein also comprising an inner shell, arranged in said upper shell and used for covering said spray chamber to form a closed chamber; said inner shell is provided with a molding groove communicated with said spray port and said spray chamber respectively; said molding groove is aligned with said emitting-light assembly; said molding groove is provided with two water mist baffles.

2. The simulating flame humidifier according to claim 1, wherein further comprising an air chamber arranged on said spray chamber, said air chamber is above a top surface of said spray chamber; said inner shell is provided with a baffle corresponding to said air chamber, said baffle forms a passageway to adjust a path of said airflow in said air chamber.

3. The simulating flame humidifier according to claim 1, wherein said inner shell is detachably connected with said spray chamber, said inner shell is connected with said upper shell.

4. The simulating flame humidifier according to claim 1, wherein said molding groove matches with said chamber; after said inner shell is connected with said spray chamber, said two water mist baffles of molding groove fits with said top surface of said chamber, said molding groove has two opposite sidewalls, said two opposite sidewalls are respectively provided with two openings communicated with said spray chamber, water mist enters said spraying port from said two openings.

5. The simulating flame humidifier according to claim 4, wherein an opening area of said spraying port is less than that of said molding groove.

6. The simulating flame humidifier according to claim 4, wherein said main engine is provided with a fan assembly communicated with said air chamber and used for blowing wind into said spray chamber.

7. The simulating flame humidifier according to claim 2, wherein said main engine is provided with an air passage extending perpendicularly to a bottom of said main engine and communicated with said air chamber, said air chamber is provided with a hole.

8. The simulating flame humidifier according to claim 7, wherein a rectifying cavity is arranged between said baffle and said hole, said rectifying cavity is communicated with said spray chamber.

9. The simulating flame humidifier according to claim 1, wherein said main engine is provided with a control assembly, coupled electrically with said atomizer and said light-emitting mechanism.

10. The simulating flame humidifier according to claim 1, wherein a side wall of said main engine is provided with a button and a lighting button, coupled electrically with said control assembly.

11. The simulating flame humidifier according to claim 1, wherein further comprising an annular inner shell connected with said spray chamber to form a closed cavity; said annular inner shell is provided with a diversion channel communicating with said spray chamber and said spraying port, said water mist generated by said atomizer is accumulated and flowed into said diversion channel and sprayed out from said spraying port.

12. The simulating flame humidifier according to claim 11, wherein a plurality of air inlet slots are provided at a periphery of said annular inner shell; said air inlet slots are communicated with said spay chamber; each of said air inlet slots has a side wall perpendicular to said annular inner shell and a bottom wall obliquely extending from said side wall toward said side wall of said spray chamber to form an air inlet.

13. The simulating flame humidifier according to claim 12, wherein said upper shell is connected with said main engine to form an annular air duct between said spay chamber and said upper wall, said annular air duct is communicated with each of said air inlet slots.

14. The simulating flame humidifier according to claim 12, wherein said diversion channel of said annular inner shell is gradually narrowed in size from said side closed to said spray chamber to the other side closed to said spray port.
